(19) United States
(12) Patent Application Publication
(10) Pub. No.: US 2011/0299839 A1
(43) Pub. Date: Dec. 8, 2011

(54) No-freeze water hose

(76) Inventors: Robert K. Harbour, Springfield, IL (US); Damon Dennis, Pawnee, IL (US)

(21) Appl. No.: 12/802,406

(22) Filed: Jun. 7, 2010

(51) Int. Cl. H05B 3/58

(52) U.S. Cl. 392/472

(57) ABSTRACT

A heatable hose assembly for keeping a liquid above freezing in below freezing ambient temperatures is provided. The heatable hose assembly comprises a flexible liquid transport hose, a thimble apparatus, and an electrical heating apparatus. The electrical heating apparatus is located partially within the flexible liquid transport hose. The heatable hose assembly provides a means for slideably adjusting the electrical heating apparatus within the flexible liquid transport hose.

### BACKGROUND OF THE INVENTION

This invention relates in general to new and useful improvements in hoses used to transport liquids from supply receptacles. In particular, this invention relates to preventing liquids carried inside such hoses from freezing in below freezing ambient conditions. Although such hoses are designed primarily to transport water from an outdoor water spigot, other supply fixtures or liquids might also employ this invention, such as indoor supply fixtures or non-flammable industrial liquids.

Conventionally, such hoses are used to transport water from outdoor spigots to various outdoor locations. For example, farmers must supply water to their livestock, breeders must supply water to their animals housed in stables, and construction workers require a supply of water to work with certain building materials. During winter months when temperatures fall below the freezing point of water, the water inside such hoses can freeze, damaging the hoses and making an alternative means of water delivery necessary. In such cases, water must be hand carried in buckets or similar vessels, which is both labor intensive and time consuming.

Many attempts have previously been made to address the problem of delivering water to outside locations in below freezing conditions. Several hose designs incorporate a heating element to provide thermal energy to the water inside the hose and prevent the water from freezing. However, such designs are often complex and expensive to construct. These hoses are also often fragile, inefficient at transferring heat, and electrically unsafe for the user to operate.

There are several types of heated hoses found in the prior art and used commercially. For example, U.S. Pat. Pub. No. 2009/0266435 discloses a heated hose with heating wires embedded within the wall of the hose and extending axially along the length of the hose. Embedded wires require a specialized manufacturing process, which significantly raises the cost of manufacture and thus the purchase cost to the consumer. Additionally, embedded wires within the hose wall generate significant heat loss to the environment, which results in inefficient heat transfer to the liquid inside the hose. These factors increase the amount of energy needed to power the hose and the associated annual cost of operation. Finally, the positioning of wires within the hose wall decreases the durability and safety of the hose over time. Significant bending or looping of the hose can cause breakage in the wires, which would not only render the hose useless, but also create unsafe exposed electrical wires that could cause injury or even death to the user.

U.S. Pat. No. 3,378,673 discloses a heated hose assembly where heat is provided via electrical heating tape wound around the hose body, where the heating tape includes high resistance electrical heating wires. Heating tape and spirally wound heating wires break and degrade with normal bending and movement of the hose. Degraded or broken heating wires present a chance for electric shock or electrocution to the user. Winding the heating tape around the hose body also creates an additional step in the assembly process, which leads to greater chances of incorrect assembly and improper hose function, in addition to an increased cost of manufacture.

U.S. Pat. No. 4,798,230 discloses a heated hose with a single inner cavity offset from the cross-sectional center of the hose. An electric heating cable is embedded within the thicker portion of the hose wall. This design requires a large quantity of hose material to create the thicker wall portion, which increases the cost of manufacture. Embedding the electric heating cable within the hose wall itself would further increase the cost of manufacture and complexity of the assembly process. Additionally, the position of the electric heating cable in the thicker portion of the hose wall creates inefficient heat transfer, raising the annual cost of operation.

U.S. Pat. No. 5,791,377 discloses an electrically heated conduit with heating wires embedded within the conduit wall and exposed at each end of the conduit. Specially designed push-on fittings connect to each end of the conduit to cover the exposed wires and complete the electrical circuit that supplies power to the conduit. This design creates the potential for live electrical wires to become exposed if the fittings degrade or become disconnected and present a safety hazard to the user. Embedded wires also necessitate a specialized manufacture process and lead to decreased durability of the conduit in normal operations, including bending and coiling of the conduit.

While the devices of the prior art patents may represent different utilities in the art, there are still many deficiencies. For example, there exists a need for a heated hose assembly that is easy and inexpensive to manufacture. Specialized manufacturing steps, such as embedding a heating element within a hose via injection molding or insertion of prefabricated components during manufacturing, increase production costs. Furthermore, steps such as wrapping heating tape around a hose or connecting specialized fittings in contact with exposed electrical wiring should be eliminated to reduce raw material needs. A simplified assembly process will reduce the likelihood of improper assembly and associated problems with operation of the device.

There also remains a need for a heated hose assembly that is efficient and inexpensive to operate. The heating element within a heated hose should be positioned to reduce heat loss to the hose wall and the environment while maximizing heat transfer to the liquid inside the hose. A heating element positioned to transfer heat efficiently will simultaneously reduce the amount of power necessary to operate the hose, which will reduce the annual cost of operation.

There is also a need for a heated hose assembly that is adjustable in relation to the amount and rate of heat delivered to the assembly. The heating element within a heated hose assembly should be slideably adjustable to accommodate different sizes and lengths of commercially available hoses. An efficiently slideably adjustable heating element is needed to ensure that the entire length of hose is provided with heat and prevent any portion of the hose from freezing with minimal operational challenges presented to the operator. An adjustable heating element is required to maximize heat transfer to the liquid within the hose and minimize heat loss to the hose wall and the environment, which will further reduce the annual cost of operation. Additionally, a heated hose assembly should be operable at different rates of power supply to compensate for the variance of heating rates needed for different temperature ranges. A hose assembly that can be adjusted to different heating rates will allow for the most efficient use of electrical power, which will reduce the cost of operation.

Additionally, there remains a need in the art for a heated hose assembly that is safe to use. The heating element and electrical wires should be insulated and positioned within the hose to minimize the chance of live electrical wires becoming exposed to the user and creating the potential for electrical shock. The heating element and electrical wires should simultaneously be positioned so that bending and coiling of the hose will not cause unnecessary distortion of the element and wires, which can lead to increased risk of exposure to live electrical wires and hazard to the user.

There also remains a need in the art for a heated hose assembly that is durable and easy to use. The heating element should be positioned to enable the user to bend and coil the hose during normal operation without increasing the chance of causing wire failure or breakage. Extended wire life will increase the useable life of the assembly itself, which will decrease replacement frequency. A heated hose assembly should also be operable with minimal additional effort, such as special connection steps or assembly steps prior to operating the hose assembly.

Finally, there is also a need for a kit that can be assembled with conventional hoses to convert such hoses to heated hoses. Such a kit should be safe and easy to install. The kit should also be adaptable to multiple lengths and sizes of hoses. Frequently, a standard length of hose such as 50 feet in length will vary by up to 6 inches per manufacturer. Therefore the position of the heating element should be adjustable within the hose to allow for variance in the amount of heating cable disposed within the hose. This adjustability is needed to ensure that the entire length of hose is heated and allow for greater control of heat transfer within the hose while eliminating the need to manufacture many different kits containing different lengths of heating element. Furthermore, the kit should have interchangeable parts that would make it easier for a user to replace individual parts instead of the entire package. Finally, the kit should allow ample fluid flow from a supply fixture with only minimal pressure drop.

### BRIEF SUMMARY OF THE INVENTION

The needs identified above are addressed by the present heatable hose assembly for keeping a liquid above freezing in below freezing ambient temperatures. The heatable hose assembly does not require specialized manufacturing processes such as injection molding or insertion of prefabricated components, which minimizes both the manufacturing cost and the purchase cost for the consumer. The heatable hose assembly contains a minimal number of parts, making it easy to manufacture. The assembly process requires very few steps, which greatly reduces the chance of improper assembly and associated operational problems.

The heatable hose assembly is also efficient and inexpensive to operate. The assembly contains an electrical heating apparatus positioned to maximize heat transfer to the liquid inside the hose and minimize heat loss to the environment, which provides for an economical annual cost of operation.

The heatable hose assembly is also adjustable in relation to the amount and rate of heat delivered to the assembly. The position of the electrical heating apparatus is adjustable to accommodate different sizes of hoses and ensure the entire length of hose is heated. The amount of power supplied to the electrical heating apparatus is also adjustable, which allows for the most efficient use of electrical power and reduces the annual cost of operation.

Additionally, the heatable hose assembly is safe to use. The electrical heating apparatus is provided with safeguards and positioned in such a way to ensure safety of the user and minimize the incidence of broken or exposed live electrical wires, which reduces the chance of electrical shock or death to the user.

Furthermore, the heatable hose assembly is durable and easy to use. The electrical heating apparatus is flexible within the assembly, which enables the assembly to bend and coil without increased risk of breakage to the electrical heating apparatus. This inherent durability of the assembly extends its life and reduces the frequency of replacement. In the event that a part should fail, individual parts would be easily replaced with minimal effort to the user. Replacing individual parts instead of the entire assembly would also make the heatable hose assembly cheaper to maintain.

Finally, the heatable hose assembly also embodies a kit to convert a conventional hose to a heatable hose assembly. This embodiment is easy to install and safe to operate to the user. The kit is also versatile and is designed to fit multiple sizes and lengths of commercially available hoses.

One embodiment of the present invention is a heatable hose assembly for keeping a liquid above freezing in below freezing ambient temperatures. The heatable hose assembly comprises a flexible liquid transport hose, a thimble apparatus, and an electrical heating apparatus. The flexible liquid transport hose comprises an elongated, tubular hose body having a receiving end and an output end. The elongated, tubular hose body is also provided with an outer surface and an inner surface extending between the receiving end and the output end of the elongated, tubular hose body. The elongated, tubular hose body is further provided with a single inner hose cavity located within the inner surface of the elongated, tubular hose body. The thimble apparatus is in operational relationship to the receiving end of the elongated, tubular hose body of the flexible liquid transport hose. The electrical heating apparatus is located partially within the single inner hose cavity of the elongated, tubular hose body of the flexible liquid transport hose.

In another embodiment, the present invention is a heatable hose adapter kit for converting a flexible liquid transport hose to a heatable hose assembly for keeping a liquid above freezing in below freezing ambient temperatures. The heatable hose adapter kit comprises an electrical heating apparatus and a thimble apparatus. The electrical heating apparatus comprises an electrical power supply cord in electrical relationship to an electrical resistance heating cable and an ambient temperature control switch. The thimble apparatus comprises a thimble body, which is provided with a fixture end, a hose end opposite of the fixture end, and an adapter end receivable to the electrical heating apparatus. The thimble body is also provided with a cable adapter apparatus having a cable opening. The cable adapter apparatus is in operational relationship to the adapter end of the thimble body. The thimble body is further provided with an inner thimble cavity extending between the fixture end, the hose end, and the adapter end of the thimble body. The heatable hose adapter kit further comprises a means for slidably adjusting the electrical heating apparatus within the thimble apparatus.

Yet another embodiment of the present invention is a heatable hose assembly for keeping a liquid above freezing in below freezing ambient temperatures. The heatable hose assembly comprises a flexible liquid transport hose, a thimble apparatus, and an electrical heating apparatus. The flexible liquid transport hose comprises an elongated, tubular hose body having a receiving end and an output end. The elongated, tubular hose body is also provided with an outer surface and an inner surface extending between the receiving end and the output end of the elongated, tubular hose body. The elongated, tubular hose body is further provided with a single inner hose cavity located within the inner surface of the elongated, tubular hose body. The thimble apparatus is in operational relationship to the receiving end of the elongated, tubular hose body of the flexible liquid transport hose. The electrical heating apparatus is located partially within the single inner hose cavity of the elongated, tubular hose body of the flexible liquid transport hose. The heatable hose assembly further comprises a means for slidably adjusting the electrical heating apparatus within the single inner hose cavity of the elongated, tubular hose body of the flexible liquid transport hose.

### BRIEF DESCRIPTION OF THE DRAWINGS

FIG. 1 is a side view showing elements of the heatable hose assembly blown apart;

FIG. 2 is a side, partial cross-sectional deconstructed view of the heatable hose assembly;

FIG. 3 is a cross-sectional view of the flexible liquid transport hose containing the electrical heating apparatus with arrows showing heat transfer from the electrical resistance heating cable into the liquid inside the flexible liquid transport hose;

FIG. 4 is a side, cross-sectional, deconstructed view of the thimble apparatus;

FIG. 5 is an electrical diagram showing the various elements of the electrical heating apparatus;

FIG. 6 is a side view of the heatable hose adapter kit; and

FIG. 7 is a side view showing two identical heatable hose assemblies connected in series.

### DETAILED DESCRIPTION

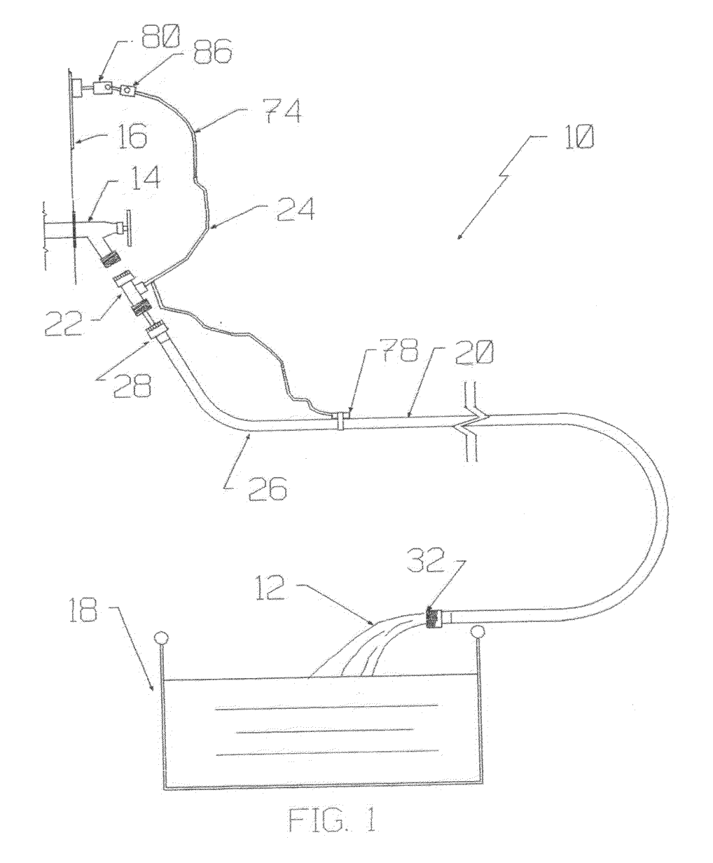

Referring now to FIG. 1, a heatable hose assembly is generally designated 10 and is intended for keeping a liquid 12 above freezing in below freezing ambient temperatures. The heatable hose assembly 10 is connectable to both a standard liquid supply fixture 14 and a standard grounded electrical supply receptacle 16 for supplying both the liquid 12 and electrical power to the heatable hose assembly 10. The heatable hose assembly 10 prevents the liquid 12 from freezing and simultaneously transports the liquid 12 to an end location 18. Most preferably, the liquid 12 is water and the standard liquid supply fixture 14 is an outdoor water spigot. The standard liquid supply fixture 14 may also be an indoor water spigot. Alternatively, the liquid 12 may be a non-flammable industrial liquid and the standard liquid supply fixture 14 may be a supply fixture for the non-flammable industrial liquid. The end location 18 may be an outdoor water trough, outdoor stable, or other distant location where a reliable supply of the liquid 12 is needed.

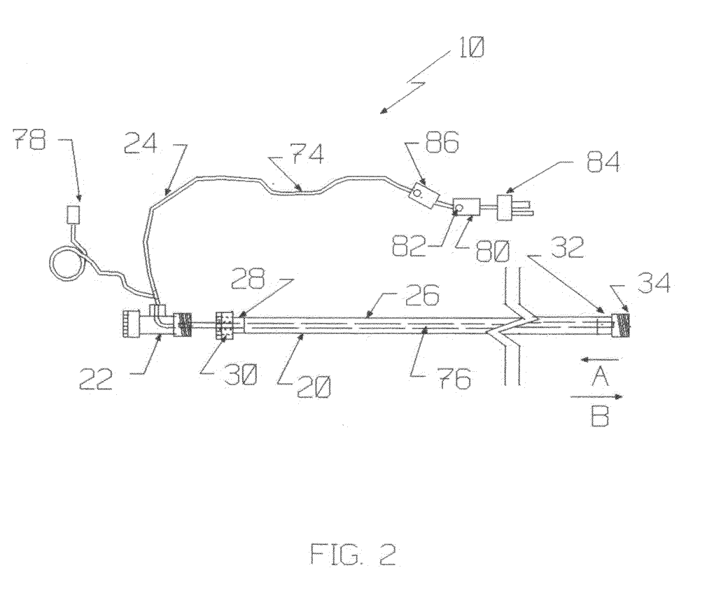

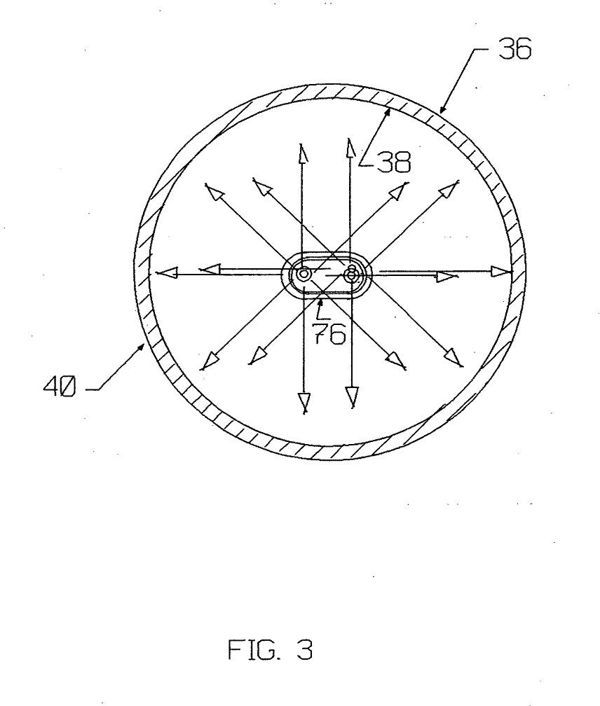

As shown in FIG. 1, FIG. 2, and FIG. 3, the heatable hose assembly 10 generally comprises a flexible liquid transport hose 20, a thimble apparatus 22, and an electrical heating apparatus 24. In one example, the flexible liquid transport hose 20 may be a 5 Ply HD Garden Hose obtained from Lowes and the thimble apparatus 22 may be a Garden Hose Shut-off Valve obtained from Menards. The flexible liquid transport hose 20 is made of a flexible, durable material, preferably a plastic or polymeric resin material. The flexible liquid transport hose 20 may vary in length, diameter, and thickness, depending on the environment in which it is used. For outdoor water needs in the winter time, the flexible liquid transport hose 20 is preferably a standard garden hose with a diameter of either ⅝ inches, ¾ inches, or another commercially available size. The flexible liquid transport hose 20 may be of any length; however, commercially available lengths are preferred between 10 feet and 100 feet in length. The flexible liquid transport hose 20 may be of standard, medium, or heavy duty grade, but is most preferably of standard grade.

The flexible liquid transport hose 20 comprises an elongated, tubular hose body 26. The elongated, tubular hose body 26 is provided with a receiving end 28 fixedly connected to a standard female threaded hose fitting 30, an output end 32 fixedly connected to a standard male threaded hose fitting 34, and an outer surface 36 and an inner surface 38 extending between the receiving end 28 and the output end 32 of the elongated, tubular hose body 26. The elongated, tubular hose body 26 is further provided with a single inner hose cavity 40 located within the inner surface 38 of the elongated, tubular hose body 26.

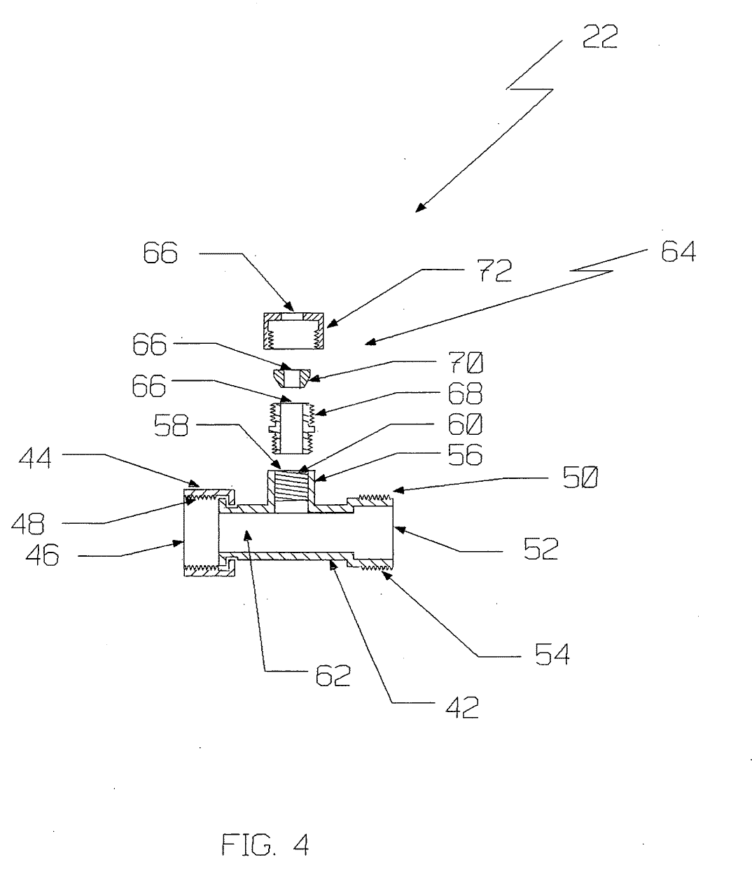

Referring now to FIG. 1 and FIG. 4, the thimble apparatus 22 is made of a durable material and provides a means of entry of both the liquid 12 and electrical power into the flexible liquid transport hose 20. Preferably, the thimble apparatus 22 is made of a brass alloy, molded PVC, or another similar durable, easily machinable material. The thimble apparatus 22 comprises a thimble body 42. The thimble body 42 is provided with a fixture end 44 containing a fixture opening 46 with an integral standard female threaded portion 48, a hose end 50 opposite of the fixture end 44 and containing a hose opening 52 with an integral standard male threaded portion 54, an adapter end 56 receivable to the electrical heating apparatus 24 and containing an adapter opening 58 with a threaded portion 60, and an inner thimble cavity 62 extending between the fixture end 44, the hose end 50, and the adapter end 56 of the thimble body 42. The thimble body 42 is further provided with a cable adapter apparatus 64 in operational relationship to the adapter end 56 of the thimble body 42 of the thimble apparatus 22. The cable adapter apparatus 64 is provided with a cable opening 66.

The thimble apparatus 22 is in operational relationship to the receiving end 28 of the elongated, tubular hose body 26 of the flexible liquid transport hose 20. Most preferably, the integral standard male threaded portion 54 of the hose opening 52 of the hose end 50 of the thimble body 42 is threadably connected to the standard female threaded hose fitting 30 fixedly connected to the receiving end 28 of the elongated, tubular hose body 26. The thimble apparatus 22 is also in operational relationship to the standard liquid supply fixture 14. Most preferably, the integral standard female threaded portion 48 of the fixture opening 46 of the fixture end 44 of the thimble body 42 is threadably connected to the standard liquid supply fixture 14.

In the preferred embodiment, the cable adapter apparatus 64 comprises a compression fitting 68 (⅜″ OD×¼′ MIP Compression Union, Menards), a tapered washer 70 (0000 Tappered Rubber Bushing, Menards), and a compression nut 72. The tapered washer 70 is provided with the cable opening 66. The compression fitting 68 and the compression nut 72 may be constructed of any rigid, durable material, but are most preferably constructed out of a brass alloy, molded PVC, or another similar durable, easily machinable material. The tapered washer 70 may be constructed of any semi-rigid, durable material, but is most preferably constructed out of rubber or plastic. The tapered washer 70 provides a leak-free entry point for the electrical heating apparatus 24 into the heatable hose assembly 10. Furthermore, the tapered washer 70 holds the electrical heating apparatus 24 in place, ensuring accurate placement of the electrical heating apparatus 24 and efficient heat transfer into the liquid 12. The tapered washer 70 also ensures safety of the user by preventing the liquid 12 from leaving the heatable hose assembly 10 and coming into contact with the standard grounded electrical supply fixture 16 or other live electrical elements in the environment, which could cause electrical shock to the user.

The cable adapter apparatus 64 is threadably connected to the adapter end 56 of the thimble body 42 of the thimble apparatus 22. Most preferably, the compression fitting 68 is threadably connected to the threaded portion 60 of the adapter opening 58 of the adapter end 56 of the thimble body 42. The tapered washer 70 is located substantially within the compression fitting 68. The compression nut 72 is threadably connected to the compression, fitting 68 and is located substantially around the tapered washer 70.

Alternatively, the thimble apparatus 22 may be manufactured to incorporate the compression fitting 68 into the adapter end 56 of the thimble body 42. In this embodiment, the tapered washer 70 is located substantially within the adapter end 56 of the thimble body 42. The compression nut 72 is threadably connected to the adapter end 56 of the thimble body 42 and is located substantially around the tapered washer 70.

Referring now to FIG. 2, the electrical heating apparatus 24 comprises an electrical power supply cord 74 in electrical relationship to an electrical resistance heating cable 76 and an ambient temperature control switch 78. The electrical resistance heating cable 76 may be a Gutter De-icing Cable, 60′, 5 watts/foot available at Menards and the ambient temperature control switch 78 may be a ThermoDisc 36T ½″ bimetal sw. 35 degrees Fahrenheit available from Emerson. The electrical power supply cord 74 is most preferably standard two-wire grounded, insulated electrical wire. The standard two-wire grounded, insulated electrical wire may be of various gauges and ratings, but is most preferably #16 stranded copper wire rated for 120 volt service. The electrical resistance heating cable 76 is standard waterproof heating cable and may be rated for between 1 watt per foot and 10 watts per foot of power supply, but is most preferably rated for 5 watts per foot. The ambient temperature control switch 78 is programmable to a cut-off temperature. When ambient temperatures are at or above the cut-off temperature, the ambient temperature control switch 78 breaks the electrical circuit within the electrical heating apparatus 24 and prevents power from being delivered to the electrical circuit. When power is no longer delivered to the electrical circuit, heat is no longer generated and the temperature of the electrical heating apparatus 24 is allowed to adjust to the ambient temperature.

In the preferred embodiment, the electrical power supply cord 74 comprises an integrated ground fault circuit interrupter 80 (GFCI—Corded with SOW 16/3, Standard NEMA 5-15P, Springfield Electric) having a functionality indicator 82. The ground fault circuit interrupter 80 breaks the electrical circuit within the electrical heating apparatus 24 in the event of a broken wire, exposed live electrical wire, or other unsafe electrical condition. The functionality indicator 82 indicates when power is being supplied to the electrical heating apparatus 24 and may be a light, alarm, visual display window, or other similar indicator apparatus, but is most preferably a light. The electrical power supply cord 74 also comprises a standard grounded electrical plug 84. The standard grounded electrical plug 84 is insertable into the standard grounded electrical supply receptacle 14. The electrical heating apparatus 24 further comprises a thyristor power controller 86 (10× pro wal Switch, 120 volts, 500 watts max., Amazon.com) in electrical relationship to the electrical power supply cord 74. The thyristor power controller 86 adjusts the amount of power supplied to the electrical resistance heating cable 76 to maximize the efficiency of the electrical heating apparatus 24 in various ambient conditions.

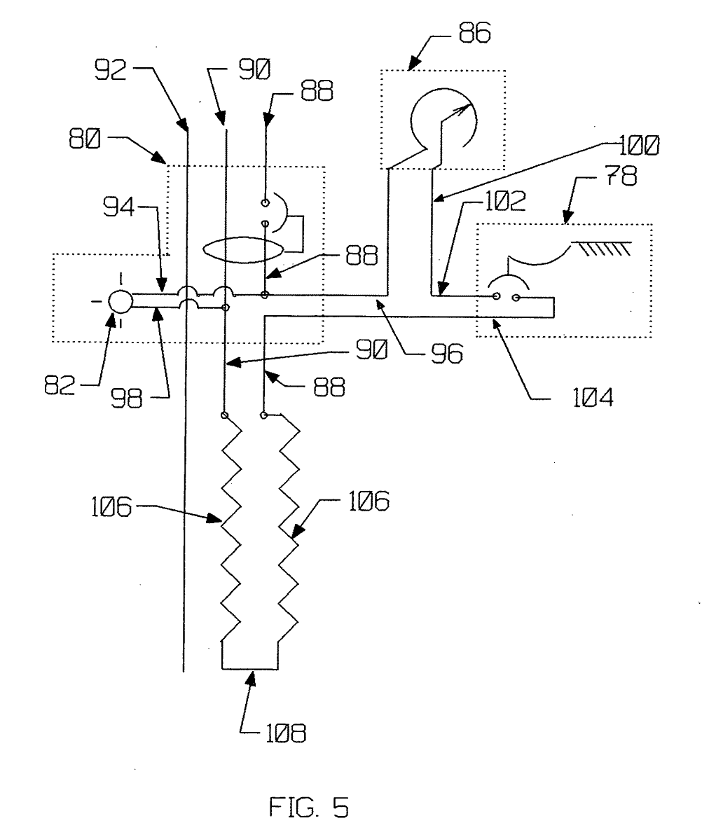

Referring now to FIG. 5, an electrical diagram of the electrical heating apparatus 24 is shown. The electrical diagram shows the preferred embodiment of the present invention where the electrical power supply cord 74 is electrically connected to the following elements in series: the ground fault circuit interrupter 80, the thyristor power controller 86, the ambient temperature control switch 78, and the electrical resistance heating cable 76. The functionality indicator 82 is connected after the ground fault circuit interrupter 80 and in parallel to both the thyristor power controller 86 and the ambient temperature control switch 78.

Referring still to FIG. 5, the electrical power supply cord 74 comprises a cord hot wire 88, a cord neutral wire 90, and a cord ground wire 92. The cord hot wire 88 is electrically connected to the ground fault circuit interrupter 80. The cord hot wire 88 is then electrically connected to an indicator input wire 94 and a controller input wire 96. The indicator input wire 94 is electrically connected to the functionality indicator 82, which is electrically connected to an indicator output wire 98. The indicator output wire 98 is electrically connected to the cord neutral wire 90. The controller input wire 96 is electrically connected to the thyristor power controller 86, which is electrically connected to a controller output wire 100. The controller output wire 100 is electrically connected to a switch input wire 102, which is electrically connected to the ambient temperature control switch 78. The ambient temperature control switch 78 is electrically connected to a switch output wire 104, which is electrically connected to the cord hot wire 88. The cord hot wire 88 and the cord neutral wire 90 are electrically connected to cable wires 106. The cable wires 106 are located within the electrical heating resistance cable 76 and are electrically connected to each other, preferably at an end point, forming a heating cable tip 108 of the electrical resistance heating cable 76.

Referring now to FIG. 1 and FIG. 2, the electrical heating apparatus 24 is located partially within the single inner hose cavity 40 of the elongated, tubular hose body 26 of the flexible liquid transport hose 20. Most preferably, the electrical resistance heating cable 76 is located within the cable opening 66 of the cable adapter apparatus 64, within the inner thimble cavity 62 of the thimble body 42 of the thimble apparatus 22, and within the single inner hose cavity 40 of the elongated, tubular hose body 26 of the flexible liquid transport hose 20. The heating cable tip 108 is most preferably located in close proximity to the output end 32 of the elongated, tubular hose body 26 of the flexible liquid transport hose 20. In this preferred embodiment, based on the electrical diagram of FIG. 5, the ambient temperature control switch 78 is located outside of the flexible liquid transport hose 20, and may be secured to the flexible liquid transport hose 20. In an alternative embodiment, the ambient temperature control switch 78 is left unsecured and detached from the flexible liquid transport hose 20 if desired by the user or manufacturer.

Alternatively, the ambient temperature control switch 78 may be incorporated directly into the electrical resistance heating cable 76. In this alternative embodiment, the ambient temperature control switch 78 is located within the single inner hose cavity 40 of the elongated, tubular hose body 26 of the flexible liquid transport hose 20.

In the preferred embodiment, the heatable hose assembly 10 is provided generally with a means for slideably adjusting the electrical heating apparatus 24 within the single inner hose cavity 40 of the elongated, tubular hose body 26 of the flexible liquid transport hose 20. More specifically, the heatable hose assembly 20 is provided with a means for slideably adjusting the electrical resistance heating cable 76 within the cable opening 66 of the cable adapter apparatus 64, within the inner thimble cavity 62 of the thimble body 42 of the thimble apparatus 22, and within the single inner hose cavity 40 of the elongated, tubular hose body 26 of the flexible liquid transport hose 20. To accommodate the means of slideably adjusting the electrical resistance heating cable 76, the compression nut 72 of the cable adapter apparatus 64 is unscrewed to a point where slack within the tapered washer 70 allows the electrical resistance heating cable 76 to move deeper into or out of the thimble apparatus 22 slideably. This means of adjustment allows the heating cable tip 108 of the electrical resistance heating cable 76 to move in the direction of arrow A or arrow B, as shown in FIG. 2, to provide the entire length of the flexible liquid transport hose 20 with sufficient heat to prevent the liquid 12 inside from freezing.

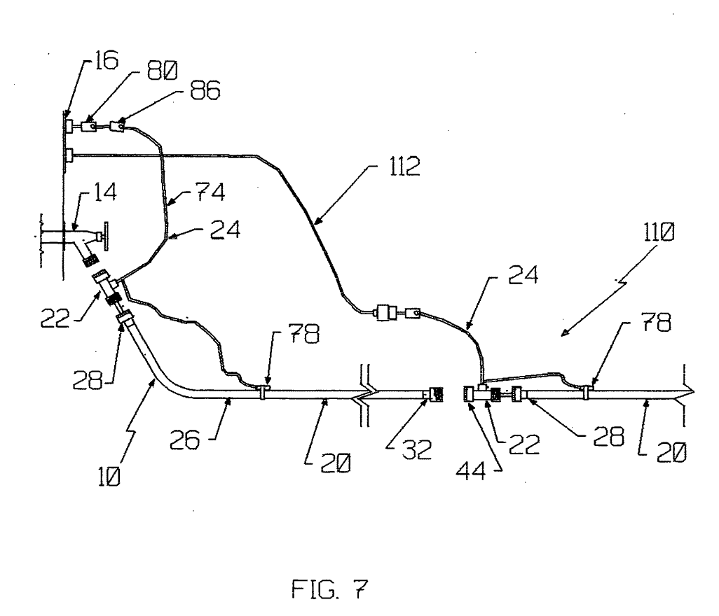

Referring now to FIG. 7, the flexible liquid transport hose 20 may be connected to an additional heatable hose assembly 110, which is a means of expanding the reach of the heatable hose assembly 10, using the same principal. More specifically, the output end 32 of the flexible liquid transport hose 20 of the heatable hose assembly 10 may be threadably connected to the fixture end 44 of the thimble apparatus 22 of the additional heatable hose assembly 110. The electrical heating apparatus 24 of the additional heatable hose assembly 110 may be directly connected to the standard grounded electrical supply receptacle 16, or may be connected to the standard grounded electrical supply receptacle 16 with a standard grounded extension cord 112, as shown. If the flexible liquid transport hose 20 is not connected to an additional hose assembly 110, the output end 32 of the flexible liquid transport hose 20 may alternatively be connected to an output fixture, such as a spray nozzle or other similar device, or to nothing at all to be left in a free flowing state.

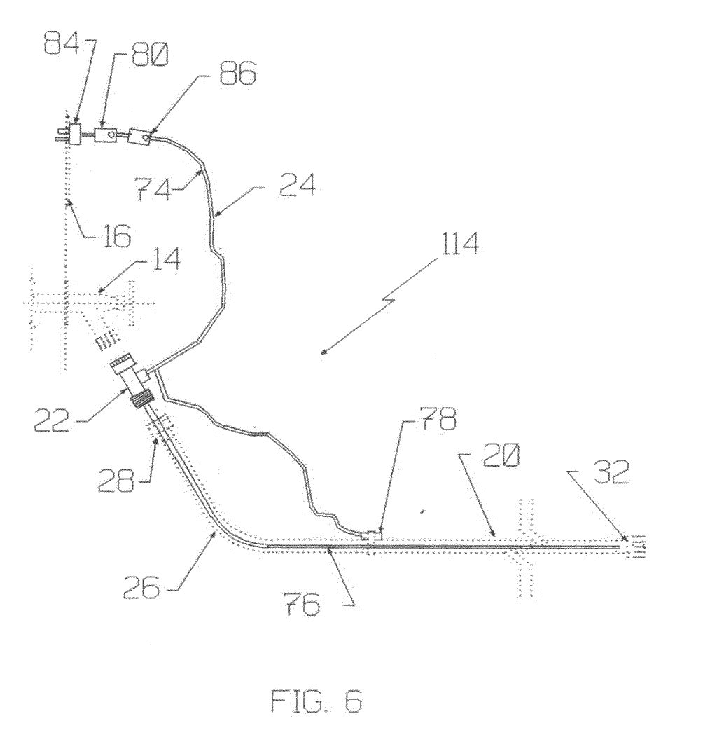

In an alternative embodiment, the present invention may be presented as a heatable hose adapter kit 114 for converting a flexible liquid transport hose 20 to a heatable hose assembly 10 for keeping a liquid 12 above freezing in below freezing ambient temperatures, as shown in FIG. 6. The heatable hose adapter kit 114 comprises an electrical heating apparatus 24 and a thimble apparatus 22 as described above. The thimble apparatus 22 is receivable to the electrical resistance heating cable 76 of the electrical heating apparatus 24, which is most preferably located partially within the thimble apparatus 22. The heatable hose adapter kit 114 further comprises a means for slideably adjusting the electrical resistance heating cable 76 within the thimble apparatus 22. To accommodate the means of slideably adjusting the electrical heating apparatus 24, the compression nut 72 of the cable adapter apparatus 64 simply needs to be unscrewed to a point where slack within the tapered washer 70 allows the electrical resistance heating cable 76 to move deeper into or out of the thimble apparatus 22 slideably, as described above.

To install the heatable hose adapter kit 114, a user simply needs to connect the thimble apparatus to a flexible liquid transport hose 20 and insert the electrical heating apparatus 24 into the flexible liquid transport hose 20 to a point where the heating cable tip 108 of the electrical resistance heating cable 76 is in close proximity to the output end 32 of the elongated, tubular hose body 26 of the flexible liquid transport hose 20. The user then simply needs to connect the heatable hose adapter kit 114 to the standard liquid supply fixture 14 and the standard grounded electrical supply receptacle 16 to supply the liquid 12 and electrical power to the heatable hose adapter kit 114.

While several particular embodiments of the present heatable hose assembly have been described herein, it will be appreciated by those skilled in the art that changes and modifications may be made thereto without departing from the invention in its broader aspects and as set forth in the following claims.

What is claimed is:

1. A heatable hose assembly for keeping a liquid above freezing in below freezing ambient temperatures, the heatable hose assembly comprising:
a flexible liquid transport hose, said flexible liquid transport hose comprising an elongated, tubular hose body having a receiving end, an output end, an outer surface and an inner surface extending between said receiving end and said output end of said elongated, tubular hose body, and a single inner hose cavity located within said inner surface of said elongated, tubular hose body;
a thimble apparatus in operational relationship to said receiving end of said elongated, tubular hose body of said flexible liquid transport hose; and
an electrical heating apparatus located partially within said single inner hose cavity of said elongated, tubular hose body of said flexible liquid transport hose.

2. The heatable hose assembly of claim 1, wherein said thimble apparatus comprises a thimble body having a fixture end, a hose end opposite of said fixture end, an adapter end receivable to said electrical heating apparatus, a cable adapter apparatus with a cable opening and in operational relationship to said adapter end of said thimble body, and an inner thimble cavity extending between said fixture end, said hose end, and said adapter end of said thimble body.

3. The heatable hose assembly of claim 2, wherein said electrical heating apparatus comprises an electrical power supply cord in electrical relationship to an electrical resistance heating cable and an ambient temperature control switch.

4. The heatable hose assembly of claim 2, wherein said hose end of said thimble body of said thimble apparatus is threadably connected to said receiving end of said elongated, tubular hose body of said flexible liquid transport hose.

5. The heatable hose assembly of claim 3, wherein said electrical resistance heating cable is located within said cable opening of said cable adapter apparatus, within said inner thimble cavity of said thimble body of said thimble apparatus, and within said single inner hose cavity of said elongated, tubular hose body of said flexible liquid transport hose.

6. The heatable hose assembly of claim 5, wherein said electrical power supply cord comprises an integrated ground fault circuit interrupter having a functionality indicator.

7. The heatable hose assembly of claim 6, wherein said ambient temperature control switch is located within said single inner hose cavity of said elongated, tubular hose body of said flexible liquid transport hose.

8. The heatable hose assembly of claim 6, wherein said ambient temperature control switch is located outside said flexible liquid transport hose.

9. The heatable hose assembly of claim 6, wherein said electrical heating apparatus further comprises a thyristor electrical power controller in electrical relationship to said electrical power supply cord.

10. The heatable hose assembly of claim 9, wherein said electrical power supply cord is standard 2-wire grounded insulated electrical wire.

11. The heatable hose assembly of claim 10, wherein said electrical resistance heating cable is rated for between 3 watts per foot and 8 watts per foot of power supply.

12. The hetatable hose assembly of claim 5, wherein said cable adapter apparatus further comprises a compression fitting, a tapered washer, and a compression nut for receiving said electrical heating apparatus.

13. A heatable hose adapter kit for converting a flexible liquid transport hose to a heatable hose assembly for keeping a liquid above freezing in below freezing ambient temperatures, the heatable hose adapter kit comprising:
an electrical heating apparatus comprising an electrical power supply cord in electrical relationship to an electrical resistance heating cable and an ambient temperature control switch;
a thimble apparatus comprising a thimble body having a fixture end, a hose end opposite of said fixture end, an adapter end receivable to said electrical heating apparatus, a cable adapter apparatus with a cable opening and in operational relationship to said adapter end of said thimble body, and an inner thimble cavity extending between said fixture end, said hose end, and said adapter end of said thimble body; and
a means for slideably adjusting said electrical heating apparatus within said thimble apparatus.

14. The heatable hose adapter kit of claim 13, wherein said electrical power supply cord comprises an integrated ground fault circuit interrupter having a functionality indicator.

15. The heatable hose adapter kit of claim 14, wherein said electrical heating apparatus further comprises a thyristor electrical power controller in electrical relationship to said electrical power supply cord.

16. The heatable hose adapter kit of claim 15, wherein said electrical power supply cord is standard 2-wire grounded insulated electrical wire

17. The heatable hose adapter kit of claim 16, wherein said electrical resistance heating cable is rated for between 3 watts per foot and 8 watts per foot of power supply.

18. The heatable hose adapter kit of claim 13, wherein said means for slideably adjusting said electrical heating apparatus within said thimble apparatus is provided by a tapered washer and a compression nut.

19. A heatable hose assembly for keeping a liquid above freezing in below freezing ambient temperatures, the heatable hose assembly comprising:
a flexible liquid transport hose, said flexible liquid transport hose comprising an elongated, tubular hose body having a receiving end, an output end, an outer surface and an inner surface extending between said receiving end and said output end of said elongated, tubular hose body, and a single inner hose cavity located within said inner surface of said elongated, tubular hose body;
a thimble apparatus in operational relationship to said receiving end of said elongated, tubular hose body of said flexible liquid transport hose, wherein said thimble apparatus comprises a thimble body having a fixture end, a hose end opposite of said fixture end, an adapter end receivable to said electrical heating apparatus, a cable adapter apparatus with a cable opening and in operational relationship to said adapter end of said thimble body, an inner thimble cavity extending between said fixture end, said hose end, and said adapter end of said thimble body;
an electrical heating apparatus located partially within said single inner hose cavity of said elongated, tubular hose body of said flexible liquid transport hose, wherein said electrical heating apparatus comprises an electrical power supply cord in electrical relationship to an electrical resistance heating cable and an ambient temperature control switch; and
a means for slideably adjusting said electrical heating apparatus within said single inner hose cavity of said elongated, tubular hose body of said flexible liquid transport hose;
wherein said hose end of said thimble body of said thimble apparatus is connected to said receiving end of said elongated, tubular hose body of said flexible liquid transport hose; and
wherein said electrical resistance heating cable is located within said cable opening of said cable adapter apparatus, within said inner thimble cavity of said thimble body of said thimble apparatus, and within said inner hose cavity of said elongated, tubular hose body of said flexible liquid transport hose.

20. The heatable hose assembly of claim 17, wherein said electrical heating apparatus further comprises a thyristor power controller in electrical relationship to said electrical power supply cord.
